(19) United States
(12) Patent Application Publication
(10) Pub. No.: US 2023/0053519 A1
(43) Pub. Date: Feb. 23, 2023

(54) MANUFACTURED OBJECT IDENTIFICATION

(71) Applicant: Hewlett-Packard Development Company, L.P., Spring, TX (US)

(72) Inventors: Faisal Azhar, Bristol (GB); Stephen Bernard Pollard, Bristol (GB); Simon Michael Winkelbach, Braunschweig (DE); Rudolf Martin, Braunschweig (DE)

(73) Assignee: Hewlett-Packard Development Company, L.P., Spring, TX (US)

(21) Appl. No.: 17/795,034

(22) PCT Filed: Feb. 19, 2020
(86) PCT No.: PCT/US2020/018823

§ 371 Date: Jul. 25, 2022

(51) Int. Cl. B29C 64/386; B33Y 50/00; G06T 19/20; G06V 10/24; G06V 10/25; G06V 30/10

(52) U.S. Cl. CPC B29C 64/386; B33Y 50/00; G06T 19/20; G06V 10/245; G06V 10/25; G06V 30/10; G06T 2219/2004

(57) ABSTRACT

Disclosed herein are methods, apparatus, and computer program code for object manufacturing (e.g. 3D printing), to align an object scan obtained from a manufactured object manufactured according to an object data file with an object representation obtained from the object data file. The manufactured object has been manufactured on a manufacturing bed of a 3D manufacturing apparatus according to the object data file. The manufactured object comprises a manufacturing parameter identifier in a region of interest defined in the object data file, the manufacturing parameter identifier indicating a manufacturing parameter of the manufactured object. The manufacturing parameter identifier in the region of interest of the aligned object scan may be computationally read.

Three dimensional (3D) printers are revolutionising additive manufacturing. Knowing the conditions under which an object has been manufactured/printed may be useful, for example for quality control.

Example implementations will now be described with reference to the accompanying drawings in which:

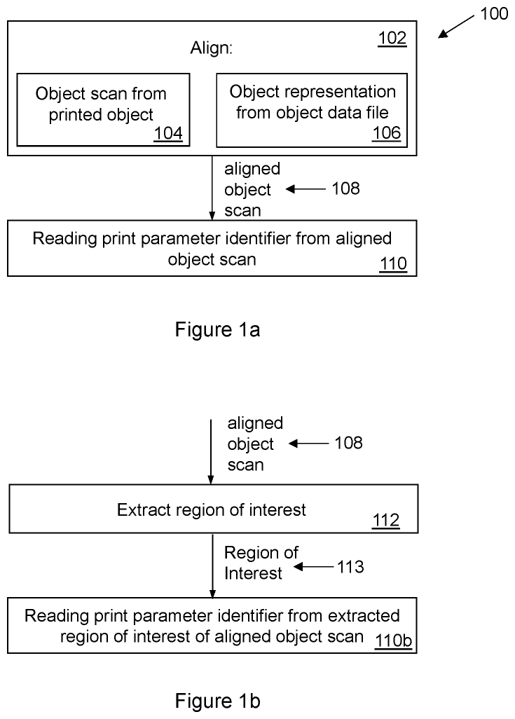

FIGS. 1a-1b show methods of identifying a manufactured object, e.g. from a region of interest, according to example implementations;

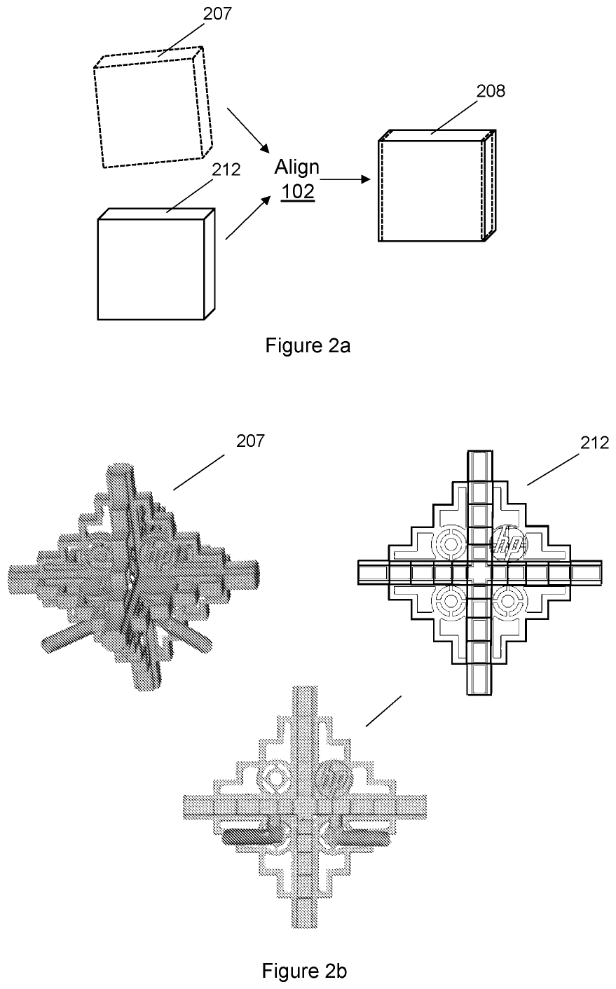

FIGS. 2a-2b illustrate aligning an object scan with an object representation according to example implementations;

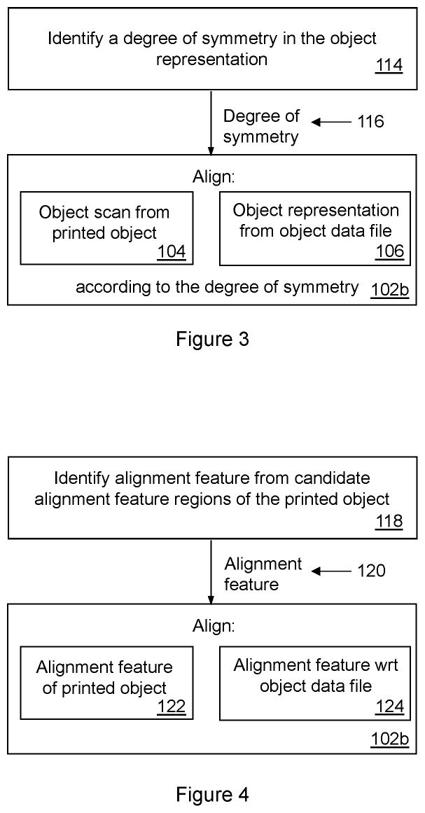

FIG. 3 shows a method of identifying a manufactured object with a degree of symmetry according to example implementations;

FIG. 4 shows a method of identifying a manufactured object with a degree of symmetry using an alignment feature according to example implementations;

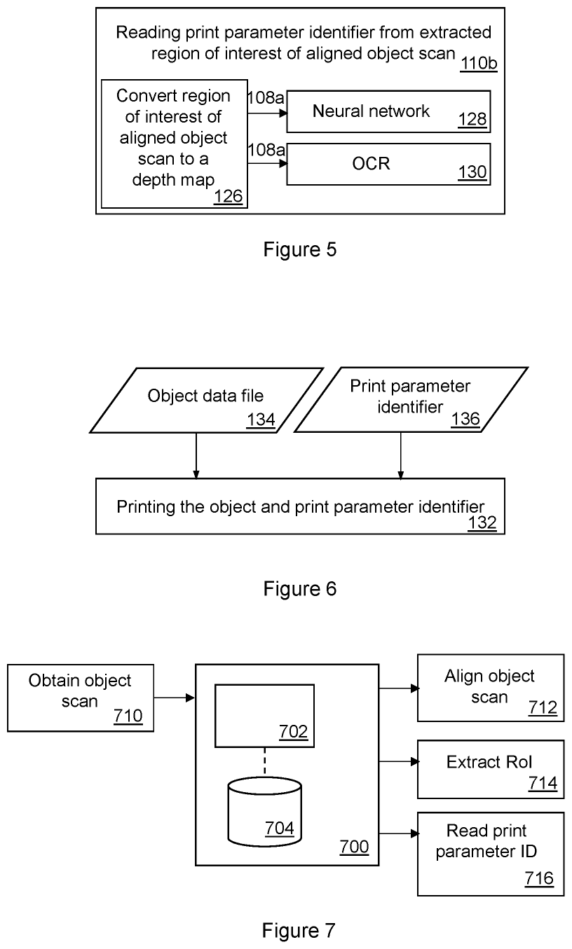

FIG. 5 shows a method of identifying a manufactured object using a depth map of an object scan of the object according to example implementations;

FIG. 6 shows a method of manufacturing the object according to example implementations;

FIG. 7 shows an example apparatus according to example implementations;

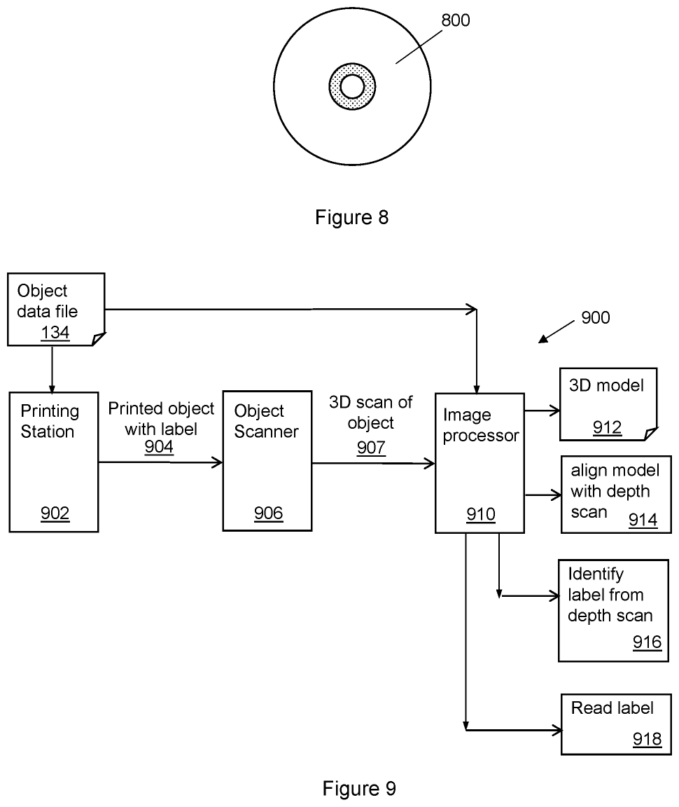

FIG. 8 shows a computer readable medium according to example implementations;

FIG. 9 shows an example manufacturing (e.g. printing) system according to example implementations;

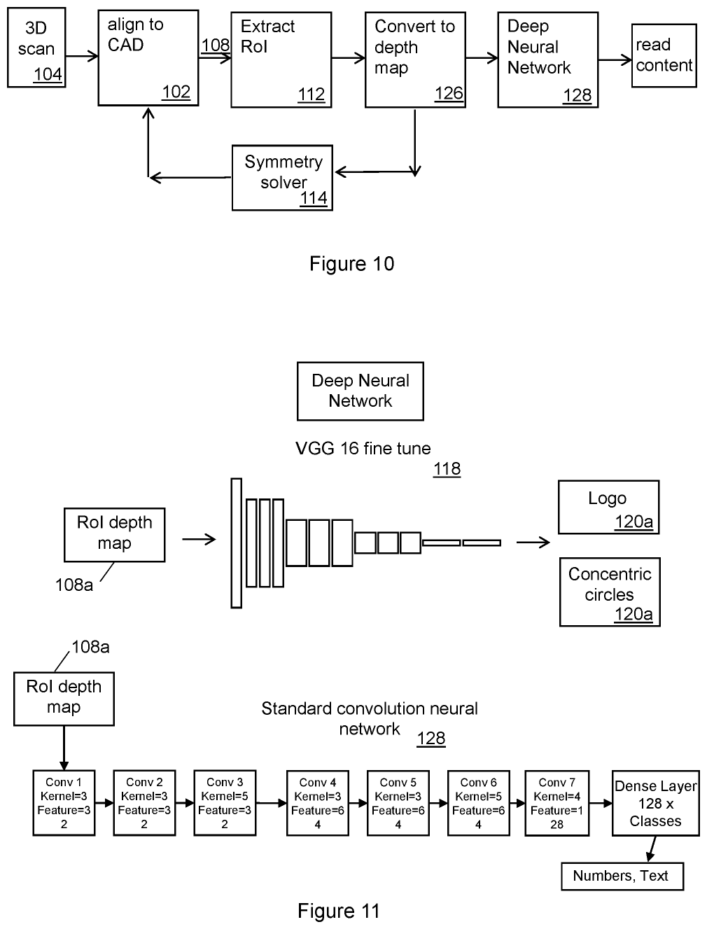

FIG. 10 shows an example method of identifying a manufactured object according to example implementations;

FIG. 11 shows a method of identifying a feature of a manufactured object using a neural network according to example implementations;

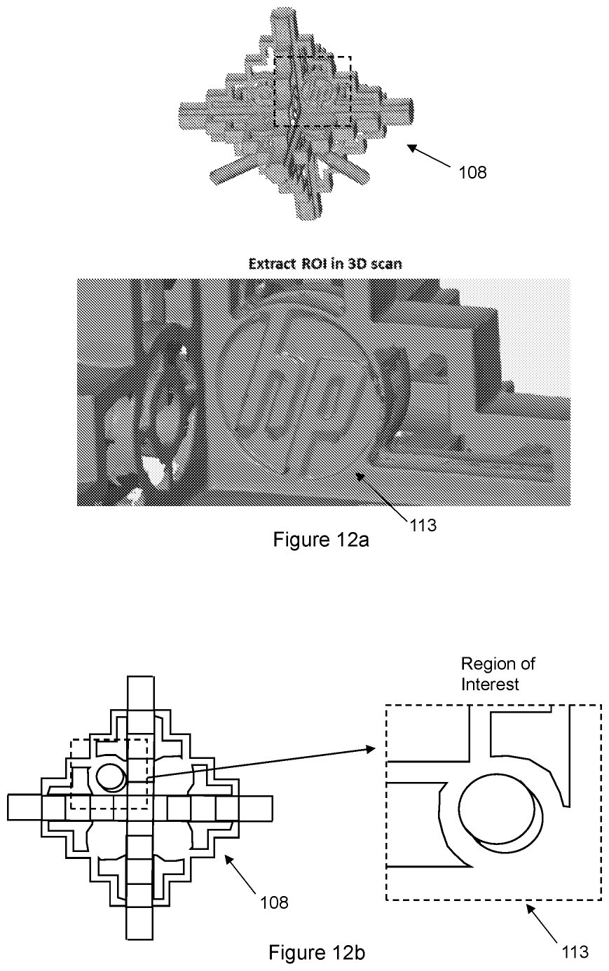

FIGS. 12a-12b show identification of an alignment marker from a 3D object scan according to example implementations;

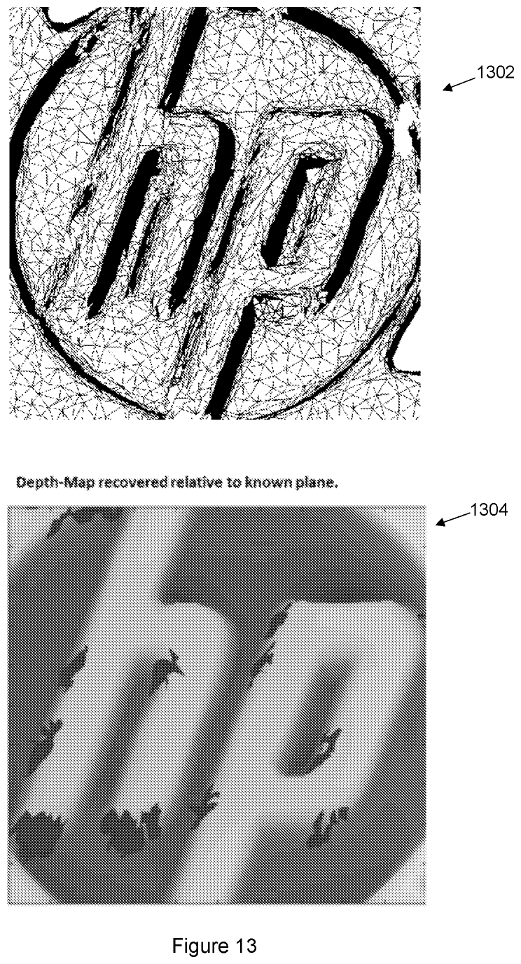

FIG. 13 shows identification of an alignment marker from a 3D object scan according to example implementations; and

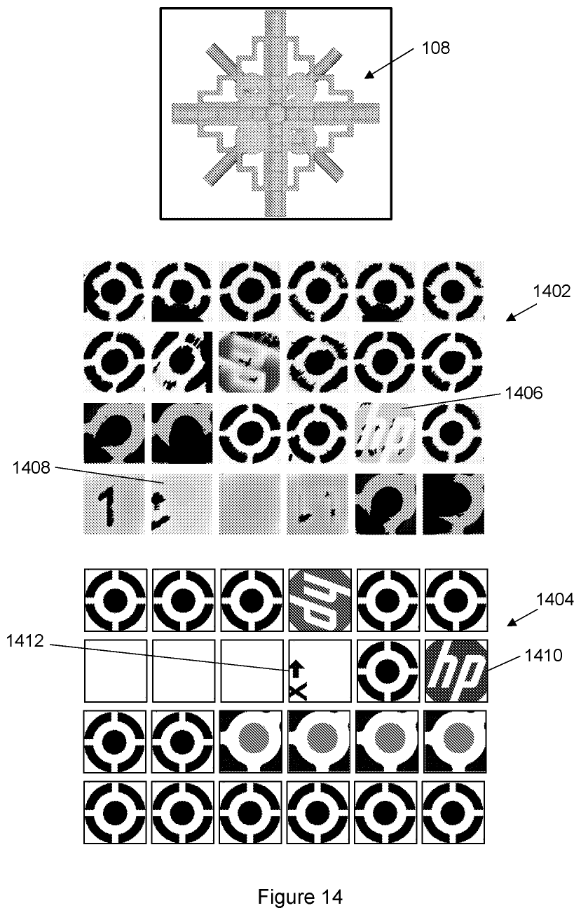

FIG. 14 shows identification of an alignment marker from a 3D object scan with a degree of symmetry according to example implementations.

Knowing the conditions under which an object has been manufactured (e.g. (3D) printed) may be useful, for example for quality control. As an example, knowing the relative location of manufactured parts may be important for location-based optimization of a 3D manufacturing apparatus (e.g. 3D printer). Thermal gradients in the manufacturing/printing environment may be present and cause non-uniform heating, leading to geometric variations in objects manufactured/printed at different locations in the manufacturing bed/print bed.

Examples disclosed here may provide a way of automatically identifying a manufactured object (e.g. a 3D printed object or part), and in some examples identifying a manufacturing parameter or plurality of manufacturing parameters relating to the manufactured object.

Described herein a method and apparatus for automatic 3D manufactured/printed part tracking, for example to identify the location of the manufactured part in the manufacturing bed. Being able to automatically identify a manufactured part and a manufacturing parameter of the manufactured part, such as location of manufacture in the manufacturing bed, print run of a plurality of print runs, build material used, time of manufacture/printing, or other parameter, may allow for improvements in quality control. Typically, after a manufactured part has been manufactured, and post processed (e.g. removing parts from the manufacturing/print bed, cleaning remaining unused build material by vacuum suction and/or bead blasting), each part is manually arranged on a support frame according to their relative locations on the manufacturing/print bed.

A digitized version or scan of each object may be obtained for comparison with the ideal shape and size (i.e. compared with the input file, for example an input design file, CAD model file, or mesh or similar derived from a CAD file), and may contain, e.g., the printed layer and location number according to which a manual operator can arrange the objects on the support frame. The parts may then be analyzed for quality control purposes, for example, the 3D geometry of the manufactured part may be compared from the initial CAD model used to manufacture/print the object and any deviation of the manufactured object may be computed).

By comparing the 3D scans of the manufactured objects to the CAD files, correction can be applied to improve calibration of a manufacturing apparatus/printer to ensure a subsequent manufacturing/print run provides objects closer matched to the input CAD file (for example, accounting for local scale and offset factors). However, current manual processes for identifying manufactured parts and identifying deviations from ideal dimensions/properties are non-scalable, labour intensive, time consuming, and prone to human error.

Technical challenges to automating the above manual process include, for example, acquiring a 3D printed layer and location number from a manufactured part; identifying/finding the layer and location after acquiring them; reading the location and layer number after identifying/finding them; and using these parameters after reading them. Such technical challenges may be addressed by examples disclosed herein.

FIG. 1 a shows a computer-implemented method 100 of identifying a manufactured object according to example implementations. A manufactured object (e.g. a 3D printed/manufactured part) is manufactured on a manufacturing bed of, for example, a 3D printer, according to an object data file (e.g. a CAD file, CAD derived mesh file or similar file specifying at least the dimensions of the object). The method 100 comprises aligning 102 an object scan (e.g. a 3D structured light scan) obtained from the manufactured object manufactured according to the object data file 104 with an object representation (i.e. a model having the dimensions and shape etc. of the object as provided as input to the 3D printer to print the object) obtained from the object data file 106. Aligning the object scan with the object representation may involve identifying a plurality of feature points in the object scan and identifying the equivalent feature points in the object representation (or identifying a plurality of feature points in the object representation and identifying the equivalent feature points in the object scan), and matching up the identified feature points by computationally moving the object scan with respect to the object representation (or virtually moving the object representation with respect to the object scan) to achieve substantial coincidence between the feature points. Aligning the object scan and object representation may involve computationally moving (e.g. translating, rotating) at least one of the object scan and object representation until a best fit is achieved in which the virtual space occupied by the object scan and the object representation is substantially the same (i.e. their volumes and/or surfaces overlap as closely as possible).

In comparing the manufactured object scan with an object representation obtained from the object data file (the input file), the manufactured object scan may be compared with a mesh file generated from the input file, for example an STL, OBJ or 3MF file format rather than against the input file (e.g. CAD model) itself. Thus aligning the object scan with the object representation may involve adjusting the object scan data to bring it into the same coordinate frame system as the object representation data. Examples of mesh and point cloud alignment are (Winkelbach, S., Molkenstruck, S., and Wahl, F. M. (2006), Low-cost laser range scanner and fast surface registration approach, In Pattern Recognition, pages 718-728. and Azhar, F., Pollard, S. and Adams, G. (2019) ‘Gaussian Curvature Criterion based Random Sample Matching for Improved 3D Registration’ at VISAPP) but it will be understood that the alignment described herein is not limited to these examples.

By performing an alignment in this way, this may be considered to be a comparison between the ideal theoretical 3D object, as defined in the object data file, and the actual 3D object as manufactured/printed in the 3D printer, and results in an aligned object scan 108. Variations between the two may arise, for example, from thermal variations in the manufacturing bed or deviations in the fusing of build materials compared with expected values.

The manufactured object comprises a manufacturing parameter identifier in a region of interest defined in the object data file. The manufacturing parameter identifier indicates a manufacturing parameter of the manufactured object, such as, for example, a location on the manufacturing bed where the manufactured object was manufactured; a layer identifier indicating the manufacturing layer where the manufactured object was manufactured; a manufacturing bed identifier indicating the location in the manufacturing layer where the manufactured object was manufactured; a manufacturing/print run identifier indicating the manufacturing/print run of a plurality of manufacturing/print runs in which the manufactured object was manufactured; a printer identifier indicating the printer used to manufacture/print the manufactured object; a timestamp indicating when the manufactured object was manufactured; and/or a build material indicator indicating a parameter of the build material used to manufacture/print the manufactured object.

The manufacturing parameter identifier may indicate such information by the full information, or a short/abbreviated version of the information, being manufactured/printed or otherwise marked on the object (e.g. “location 5” stating the manufacturing/print location, or “L5” for a shorthand way of stating the manufacturing/print location as location 5). The manufacturing parameter identifier may indicate such information by providing an encoded descriptor (for example a lookup key for identifying the information from a database, an alphanumeric encoding, or a barcode/QR code or other graphical encoding or a known unique pattern). Such a descriptor/identifier may uniquely identify the manufactured part, and in such examples, may provide track and trace capabilities to follow the processing of the object.

In some examples, the manufacturing parameter may be a part of the object to be manufactured as defined in the input object data file itself. For example, the manufacturing parameter may be a date/time of manufacturing/printing included in the object data file. In some examples, the manufacturing parameter may be identified in a separate file from the object data file and the object data file and manufacturing parameter file may be combined or otherwise each provided to the 3D printer to manufacturing/print the object with the manufacturing parameter as part of the object. For example, there may be a “master” object data file specifying the shape of the object and an indication of a region of interest or manufacturing parameter location on the object where the manufacturing parameter is to be manufactured, and the manufacturing parameter is to be printed/marked in this identified region of interest/manufacturing parameter location. This may be useful, for example, if the manufacturing parameter indicates the location on the manufacturing bed where the object was manufactured, and a plurality of objects are manufactured in the same manufacturing/print run on the manufacturing bed. One object data file can be used for all the manufactured objects in the manufacturing/print run, with a different manufacturing parameter indicating the location of manufacturing/print of each object printed/marked on the corresponding object. The manufacturing parameter in some examples may be added dynamically by the manufacturing apparatus (e.g. printer) operating system (OS).

The method 100 then comprises computationally reading 110 the manufacturing parameter identifier in the region of interest of the aligned object scan 108. The method 100 provides a computationally automated way of identifying an object by reading a manufacturing parameter (identifying an aspect of the manufactured object) from the object through comparing a 3D representation of the real object with a 3D representation taken from the input file for manufacturing/printing the object.

FIG. 1b shows a method of identifying a manufactured object from a region of interest 113 according to example implementations. The region of interest 113 (for example, a sub-region of the overall manufactured object) may be extracted 112 from the aligned object scan 108 using the region of interest defined in the object data file. The manufacturing parameter identifier may then be computationally read 110b from the extracted region of interest 113. For example, a complex object may comprise a small area in which the manufacturing parameter is located. Rather than identifying and reading the manufacturing parameter from the aligned object scan 108 of the entire complex object, the manufacturing parameter may be identified and read from the region of interest 113 extracted from the aligned object scan 108.

FIGS. 2a-2b illustrate 102 an object scan 207 (e.g. a 3D structured light scan taken from one or multiple locations/viewpoints) obtained from the manufactured object manufactured according to the object data file, compared with an object representation 212 (i.e. a model having the dimensions and shape etc. of the object as provided as input to the 3D printer to manufacture/print the object) obtained from the object data file (e.g. a CAD file). The two 207,212 may be aligned to obtain an aligned object scan 208.

FIG. 2b illustrates a real world example of aligning a 3D object scan 207 with an object representation 212 from the CAD file used to manufacture/print the object, to obtain an aligned object scan 208 aligned with the CAD file representation 212. The real world object in these examples may be termed a “snowflake” due to its symmetrical branched shape, and may be used for calibration of a 3D printer.

In some examples, the symmetry of the manufactured object is accounted for when aligning the object scan so that the object scan is correctly aligned, for example from the identification of a printed/marked feature expected in a region of interest of the object. FIG. 3 shows a method of identifying a manufactured object with a degree of symmetry 116 according to example implementations. FIG. 3 illustrates identifying that the object representation comprises a degree of symmetry 114; and that aligning the object scan with the object representation comprises aligning the object scan 104 in a correct orientation with the object representation 106 according to the degree of symmetry of the object representation 102b. In some examples such as that shown in FIG. 2b, objects may have a degree of symmetry 116 (i.e. rotational symmetry of a degree or plurality of degrees, about one or a plurality of axes of symmetry). By aligning the object scan 104 with the object representation 106 while accounting for the degree of symmetry 116 of the object, identifying a region of interest comprising the manufacturing parameter may be performed. Omitting to account for the degree of symmetry may lead to attempting to read a manufacturing parameter in an incorrect, but symmetrically equivalent, “region of interest” location on the object, to a region of interest in which the manufacturing parameter is actually located.

FIG. 4 shows a method of identifying a manufactured object with a degree of symmetry according to example implementations. FIG. 4 shows that, when the object representation comprises a degree of symmetry, the manufactured object may comprise an alignment feature 120 in an alignment feature region of the manufactured object to break the symmetry of the manufactured object manufactured according to the object data file. Such an alignment feature may be included with the object data file, either as an integral part of the object data file or alongside it for manufacturing/printing as a part of the manufactured object. The alignment feature 120 may also be considered to be a symmetry breaking feature, or a fiducial marker, which may be used to align a scan of the manufactured object with the object data file used to manufacturing/print the object.

FIG. 4 shows that aligning the object scan with the object representation may comprise identifying the alignment feature from a candidate alignment feature regions of the manufactured object 118; and aligning 102b the alignment feature 120 of the manufactured object 122 with the alignment feature 120 represented with the object data file 124. The alignment feature 120 may be considered to be “represented” with the object data file in some examples in that the alignment feature 120 is part of the object file itself. In this case, the manufactured object may be considered to be symmetrical in the sense that, while the 3-D shape itself has symmetry, the alignment feature is small or inconspicuous enough to be considered an “insignificant” marking with respect to the rest of the 3D object to the extent that the manufactured objects manufactured either with or without the alignment feature substantially of the same functionality and/or appearance). In other examples, the alignment feature 120 being “represented” with the object data file may be considered to mean that the alignment feature is included at manufacturing/print time as an addition to the manufacturing/print job file.

If no alignment feature is included in an otherwise symmetrical object, identifying the manufacturing parameter (e.g. in a region of interest) may involve identifying all possible regions of interest (as different regions having an equivalent location on the object following rotation about an axis of symmetry) and determining for each one if a manufacturing parameter is present in that region, which may be computationally inefficient or lack robustness compared with unambiguously identifying the location of the manufacturing parameter in a symmetrical object. For example, false positive detections of features mistaken for a manufacturing parameter (e.g. a line/crease may be mis-read as a “1” (digit) or “l” (lower case letter), a bubble or ring may be mistaken for an “o” (letter) or “0” (zero numeral)) may be made more frequently if multiple regions potentially including the manufacturing parameter are checked. Examples of candidate regions of interest of an object showing alignment marker and a manufacturing parameter, are shown in FIGS. 14a-b. Thus it may be helpful to break the symmetry of the object by including an alignment feature in the manufactured object, allowing the 3D object scan of the manufactured object to be mapped in a unique way to the object representation (for example to aid in identifying a region of interest in which the manufacturing parameter is located).

In some examples, aligning the alignment feature of the manufactured object 122 with the alignment feature included with the object representation 124 comprises identifying the alignment feature in the object scan of the manufactured object 122 using pattern identification and/or neural network-based pattern identification. The alignment feature may have a shape of form which allows it to be identified in the object scan unambiguously compared to other features of the object. In some examples the alignment feature may be a logo included once as the alignment feature. In some examples the alignment feature may be a fiducial marker, such as concentric circles or other shape, to allow for alignment and to be identified as an alignment marker. Pattern identification may be, used to identify simple geometric shapes such as concentric circles or a “plus” shaped marker, for example, if such shapes are different from the remaining form of the manufactured object. Neural network based pattern identification may be used to identify more complex-shaped alignment markers such as logos, or to identify an alignment marker in an otherwise complex object such as an object having varying feature scales, shapes, angles, and a high number of features. An example neural network for use in identifying an alignment marker is a VGG 16 neural network, which is represented in FIG. 11. A VGG 16 neural network is an example of a convolutional neural network (CNN). Deep CNNs have layers of processing, involving linear and non-linear operators, and may be used for feature extraction from graphical, audiovisual and textual data, for example. Other neural networks may be used for alignment marker identification in other examples

FIG. 5 shows a method of identifying a manufactured object using a depth map of an object scan of the object according to example implementations. Computationally reading the manufacturing parameter identifier 110b may comprise converting the region of interest (RoI) of the aligned object scan to a depth map 126. A depth map image retains spatial structure, and may be expressed as a 2D array, which facilitates the use of a neural network (accepting a 2D array as input) for manufacturing parameter identification. In other examples a 3D array may be used. An object scan, or RoI of an object scan, may be converted to a depth map by generating the depth map from a mesh representing the object scan relative to a known plane of the object. In some examples, the depth map may be constructed by projecting the mesh onto a plane defined with respect to the model (for example a grid may be defined with respect to a plane in the model and for each element the closest/most positive point in the scan mesh in the RoI may be determined using orthographic projection).

From the depth map 108a (which is a representation of the object scan 108), the manufacturing parameter identifier may be computationally read using a neural network 128 and/or optical character recognition 130. An example neural network approach is to use a neural network designed for single digit recognition using the MNIST (Modified National Institute of Standards and Technology) database, which allows recorded alphanumeric digits to be compared to the manufacturing parameter in the object scan to identify alphanumeric characters. The MNIST database is a large collection of handwritten digits which is used as training data for machine learning so that other characters (e.g. a manufacturing parameter) may be computationally recognized and identified. Optical character recognition (OCR) may also be used to recognize (i.e. to computationally read) alphanumeric manufacturing parameters depending on the image data obtained of the manufacturing parameter for the object scan. Clearer, 2D-like, and/or more standard characters forms may be read by OCR in some examples. Obscured, 3D-like, and/or less standard character forms may be read using a neural network model. For non-alphanumeric manufacturing parameters (e.g. graphical representations of manufacturing parameters such as encoded information or a link to a manufacturing parameter field in a lookup table or database), neural networks trained based on graphical representations may be used (e.g. the VGG 16 model). In examples employing a neural network to recognize an alignment feature and/or a manufacturing parameters, scanned features of manufactured objects which are computationally read using neural networks may also be taken as training data input for the model to fine tune feature recognition for future scanned objects, thereby improving recognition of subsequent scanned alignment features and/or a manufacturing parameters by training the neural network models with data from the 3D object feature recognition/reading applications discussed herein.

In some examples, the alignment feature region and the region of interest may coincide. In such examples, the alignment feature and the manufacturing parameter identifier may be the same printed/marked feature. In such examples, the printed/marked feature thereby both breaks the symmetry of the manufactured object, and indicates the manufacturing parameter of the manufactured object. For example, a marker of “P4” may be present on the object to both break the symmetry of the object (as “P4” does not appear elsewhere on the object) and indicate a manufacturing parameter (e.g. the object was manufactured/printed on a fourth manufacturing/print run). The printed/marked feature need not be alphanumeric, and may for example by a graphical shape encoding the manufacturing parameter information (e.g. barcode or QR type code), or may be a symbol or code corresponding to an entry in a manufacturing parameter lookup table indicating manufacturing parameters for the object. In such examples, two “special” separate markings are not printed/marked on the object, one to break the symmetry and another to indicate the manufacturing parameter respectively. Instead, one combined marking may provide both the manufacturing parameter and the alignment feature.

FIG. 6 shows a method of manufacturing/printing the object according to example implementations, by manufacturing/printing the object 132 according to the object data file 134 and manufacturing/printing the manufacturing parameter identifier 136 in the region of interest defined in the object data file.

In some examples, there may be a plurality of manufactured objects manufactured according to the object data file (for example, printing the same object may be repeated at different locations on the manufacturing bed, or manufactured in different print runs). Each manufactured object may comprise a unique manufacturing parameter identifier in a region of interest defined in the object data file. The object scan obtained from each manufactured object manufactured according to the object data file may be aligned with the object representation obtained from the object data file; and the unique manufacturing parameter identifier in the region of interest of each of the aligned object scans may be computationally read. For example, eight objects may be manufactured using the same object data file as input, and each may comprise a manufacturing parameter indicating which object in the series of eight the marked object is (e.g. a manufacturing parameter indicating object 6 of 8 as the sixth object manufactured in a series of eight of the same object).

FIG. 7 shows an example apparatus 700. The apparatus 700 may be used to carry out the methods described above. The apparatus 700 comprises a processor 702; a computer readable storage 704 coupled to the processor 702; and an instruction set to cooperate with the processor 702 and the computer readable storage 704 to: obtain an object scan 710 of an object manufactured by a 3D printer, the object manufactured according to an object data file defining the object geometry and a region of interest of the object, the object comprising a manufacturing parameter identifier in the region of interest indicating a manufacturing parameter of the manufactured object; align the obtained object scan with an object representation obtained from the object data file 712; extract the region of interest from the aligned object scan according to the region of interest defined in the object data file 714; and read the manufacturing parameter identifier in the region of interest of the aligned object scan 716. The object scan may be obtained 710, for example, by receiving a scan from a scanning apparatus separate from and in communication with the apparatus 700, or may be obtained by the apparatus 700 comprising scanning means to scan the manufactured object and generate the object scan. The processor 702 may comprise any suitable electronic processor (e.g., a microprocessor, a microcontroller, an application specific integrated circuit (ASIC), a field-programmable gate array (FPGA), etc.) that is configured to execute electronic instructions. The computer readable storage 704 may comprise any suitable memory device and may store a variety of data, information, instructions, or other data structures, and may have instructions for software, firmware, programs, algorithms, scripts, applications, etc. stored therein or thereon that may perform any method disclosed herein.

FIG. 8 shows a computer readable medium 800 according to example implementations. The computer readable medium may comprise code to, when executed by a processor, cause the processor to perform any method described above. For example, the computer readable storage medium 800 (which may be non-transitory) may have executable instructions stored thereon which, when executed by a processor, cause the processor to match (i.e. align) a 3D object scan of a 3D manufactured object according to a CAD object data file with a 3D representation of the object from the CAD object data. That is, the 3D object scan and 3D manufactured object are processed, by the processor, to align them/match them with each other such that they are oriented in the same way and occupy substantially the same virtual space. The 3D manufactured object comprises a region of interest containing a label, the label identifying a manufacturing parameter associated with the 3D manufactured object. The executable instructions are, when executed by a processor, to cause the processor to identify the region of interest in the 3D object scan based on the region of interest in the 3D representation; and obtain the manufacturing parameter from the region of interest identified in the 3D object scan. The machine readable storage 800 can be realised using any type or volatile or non-volatile (non-transitory) storage such as, for example, memory, a ROM, RAM, EEPROM, optical storage and the like.

The (non-transitory) computer readable storage medium 800 having executable instructions stored thereon in some examples may, when executed by a processor, cause the processor to match/align the 3D object scan with the 3D representation of the object by identifying a fiducial feature (i.e. an alignment feature) included in the 3D object scan; and aligning the 3D object scan with the 3D representation by aligning the fiducial feature in the 3D object scan with a corresponding fiducial feature of the 3D representation.

The (non-transitory) computer readable storage medium 800 having executable instructions stored thereon in some examples may, when executed by a processor, cause the processor to obtain the manufacturing/parameter from the region of interest by identifying an alphanumeric character printed in/marked on the 3D manufactured object using character recognition (e.g. Optical Character Recognition, OCR, or through a neural network using e.g. an MNIST data set), the alphanumeric character representing the manufacturing/parameter.

FIG. 9 shows an example manufacturing (e.g. 3D printing) system 900 according to example implementations. The manufacturing system comprises a manufacturing station 902 for manufacturing (e.g. 3D printing) an object 904; an object scanner 906; and an image processor 910. The manufacturing station 902 is to manufacture a 3D object 904 according to an object data file 134 defining the object geometry and a label identifying a manufacturing parameter as discussed above. The object scanner 906 is to obtain a 3D depth scan 907 of the 3D manufactured object 904. For example, the object scanner may a structured light scanner, and/or may perform a multiple or single view 3D scan of the manufactured object. Depth data or point cloud data may be obtained providing the 3D object scan of the manufactured part. The image processor 910 is to: obtain a 3D model 912 of the 3D object 904 from the object data file 134; align 914 the 3D model 912 with the 3D depth scan 907 of the 3D manufactured object 904; identify 916 the label in the aligned 3D depth scan; and read 918 the identified label to determine the manufacturing parameter for output.

In some examples the image processor 910 may be remote from and in communication with the manufacturing station 902 and object scanner 906 (and may, for example, be located at a remote server or cloud for remote processing of the 3D depth scan 907 obtained from the object scanner 906, and/or remote processing of the object data file 134 to obtain the 3D model 912). In some examples the manufacturing station 902 and object scanner 906 may be part of the same composite apparatus to both manufacture (e.g. 3D print) the objects and scan the objects to obtain a 3D depth scan.

FIG. 10 shows an example method workflow of identifying a manufactured object according to an example implementation. In this example, a 3D scan 104 of a manufactured object is provided. Next, a 3D alignment method is used to align 102 the 3D scan 104 of a manufactured instance to the CAD model used to manufacture it. This allows for extracting of a Region of Interest (RoI) from the 3D scan 104, i.e. the location of relevant printed/marked content on the 3D scan of the manufactured part, which may be performed by knowing the location of the RoI from the CAD model and matching this location to the equivalent location on the aligned 3D scan (see also FIG. 2).

The RoI in this example is converted to a depth map image 126 for ease of processing by a neural network. Also, in this example, a symmetry solver 114 verifies and correct the alignment by searching through the alternative RoI locations between the 3D scan 104 and the 3D representation obtained from the CAD file (see also FIGS. 4 and 14a-b). For simple RoI patterns basic similarity matching may be used between the two depth images, but for more complex patterns, deep machine learning methods (e.g. a VGG 16 neural network) may be used to align the 3D scan of an object with the 3D representation of the object from the CAD file for a symmetric shape. The upper part of FIG. 11 represents identifying a feature of a manufactured object 120a from a RoI depth map 108a of the manufactured object using a neural network 118 (in this example a VGG 16 neural network). Transfer learning may be used to fine tune the neural network to recognize, for example, the difference between a logo 120a and a fiducial-type marker such as concentric circles 120a as the alignment feature. Pre-trained or re-trained standard neural networks, for example convolutional neural networks (CNN) (e.g. trained using an MNIST digit dataset or other dataset of characters) 128 may be used to recognize numbers and letters/text from the RoI depth map 108a (e.g. as the manufacturing parameter marked on the object). A convolutional neural network (CNN) is represented as an example in the lower part of FIG. 11. In some examples, such a CNN may be used and re-trained using a data set relating to a particular application, for example to read an alphanumeric feature from a particular manufactured object such as a “snowflake” object described herein. However, in other examples, other datasets specific to the object and manufacturing parameters may be used to train the neural network for recognition of manufacturing parameters in future-analysed manufactured objects. In the neural network illustrated in FIG. 11, multiple convolutional layers are used with kernels of different sizes (e.g., 3, 4, 5) to learn features (maps of size 32, 64 and 128) from the input dataset to be able to read input patterns/classes. The last dense layer is used to assign a class or category (e.g., label L1, L2) to each read pattern or input depth map.

FIGS. 12a-12b show identification of an alignment marker from a 3D object scan according to example implementations. FIG. 12a is a real-world representation of an aligned 3D scan 108 of a 3D manufactured calibration object as in FIG. 2b. This shape has twenty-four degrees of rotational symmetry if the alignment feature is not considered. That is, there are 24 separate discs (either logo, manufacturing/print identifier, circle or mounting bracket) each of which can be oriented to occupy the same overall pose. The rotational symmetry of this object is similar to that of a cube. The RoI of this object 113, which includes the alignment feature, is shown on the right of FIG. 12a. In this example the RoI of the 3D scan contains an alignment feature which is a logo, and breaks the symmetry of the calibration object allowing one way to map the object scan with the object representation obtained from the object data file. FIG. 12b schematically shows the same as FIG. 12a for clarity, namely an object scan 108 (on the left) aligned with a CAD model of the object. From the aligned object scan 108, a particular RoI 113 of the object (containing a circle feature in this example) may be extracted or focused on. In other examples, the region in which the manufacturing parameter is located may be focused on by identifying the RoI in the object data file, matching the object scan with the object data file representation of the object, focusing on the RoI in the object scan, and computationally reading the manufacturing parameter located there.

FIG. 13 shows identification of an alignment marker from a 3D object scan according to an example real world implementation. At the top a mesh 1302 representation is shown of an alignment marker (an “index mark”) in the shape of a logo, obtained from a scan of the manufactured object. At the bottom a depth map 1304 is shown of the alignment marker, which has been recovered/generated from the mesh 1302 relative to a known plane of the object. In some examples the RoI may be extracted by defining a volume around the RoI location of the model and identifying the part of the scan mesh that, when aligned, lies within that volume. In some examples, the depth map may be constructed by projecting the mesh onto a plane defined with respect to the model (for example a grid may be defined with respect to a plane in the model and for each element the closest/most positive point in the scan mesh in the RoI may be determined using orthographic projection). An example of a way to define the RoI and 2D depth map projection together may be to attach a “virtual orthographic camera” to the CAD model that looks straight onto the alignment marker, and crops everything outside of the RoI. After aligning the scan with the CAD model (or vice-versa), this virtual camera may be used to render an orthographic projection of the label (using depth instead of color values per pixel).

FIGS. 14 shows identification of an alignment marker 1406 and a manufacturing parameter 1408 from a 3D object scan 108 with multiple degrees of symmetry according to example implementations. FIG. 14 shows a real-world representation of a 3D scan 108 of a 3D manufactured calibration object as in FIG. 2b. Extracted RoIs 1402 are shown as obtained from multiple points of view (i.e. the object is scanned from a plurality of different directions to obtain the single multi-view object scan 108). The manufactured object shape has 24-fold rotational symmetry if the alignment feature 1406 and manufacturing parameter 1408 are not considered. The alignment feature 1406, 1410 in this example is a logo (in fact two logos are included in this example, each having different orientations with respect to the object, and each of them can act as an alignment feature).

To align this scan 108 with the object representation from the object data file, the correct alignment needs to be identified by identifying the alignment feature 1406 included in the object to break the object symmetry (i.e. allow one orientation of the object scan to match the object representation from the object data file). Aligning the object scan 108 with the object representation in this example thus comprises identifying the alignment feature 1406 from a candidate alignment feature region or regions of the manufactured object 108. The centrally shown series of RoIs 1402 extracted from the object scan 108 show twenty four candidate alignment feature regions taken from the object scan. The bottom-most series of RoIs 1404 are taken from equivalent features from the representation obtained from the object data file. In this example it can be seen the object data scan 108 needs to be rotated to correspond to the object representation.

Therefore, examples disclosed here may facilitate the full automation and computerization of the identification process of 3D manufactured objects including objects with symmetry, for use in 3D printer calibration and quality control of 3D manufactured parts, for example. Possible applications include automatically tracking a manufacturing/print journey of a manufactured part, including tracking manufacturing parameters of the manufactured part such as manufacturing bed location. Manufactured parts may be identified for automatic sorting, for example based on content, batch, or subsequent workflow destination, for example on the basis of the manufacturing parameter and/or an automatically identified symbol, logo or batch marker present on the object. Through computational recognition of manufacturing parameters and/or alignment markers present in the manufactured parts, alignment and manufacturing parameter issues may be detected and corrected for.

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the context suggests otherwise. In particular, where the indefinite article is used, the specification is to be understood as contemplating plurality as well as singularity, unless the context suggests otherwise.

1. A computer-implemented method comprising:
aligning an object scan obtained from a manufactured object manufactured according to an object data file with an object representation obtained from the object data file; wherein the manufactured object was manufactured on a manufacturing bed of a 3D manufacturing apparatus according to the object data file, and wherein the manufactured object comprises a manufacturing parameter identifier in a region of interest defined in the object data file, the manufacturing parameter identifier indicating a manufacturing parameter of the manufactured object; and
computationally reading the manufacturing parameter identifier in the region of interest of the aligned object scan.

2. The method according to claim 1, comprising:
extracting the region of interest from the aligned object scan using the region of interest defined in the object data file; and
computationally reading the manufacturing parameter identifier from the extracted region of interest.

3. The method according to claim 1, wherein the manufacturing parameter identifier indicates one of more of:
a location on the manufacturing bed where the manufactured object was manufactured;
a layer identifier indicating the manufacturing layer where the manufactured object was manufactured;
a manufacturing bed identifier indicating the location in the manufacturing layer where the manufactured object was manufactured;
a manufacturing run identifier indicating the manufacturing run of a plurality of manufacturing runs in which the manufactured object was manufactured;
a manufacturing apparatus identifier indicating the manufacturing apparatus used to manufacture the manufactured object;
a timestamp indicating when the manufactured object was manufactured; and
a build material indicator indicating a parameter of the build material used to manufacture the manufactured object.

4. The method according to claim 1, wherein the method comprises:
identifying that the object representation comprises a degree of symmetry; and aligning the object scan with the object representation comprises:
aligning the object scan in a correct orientation with the object representation according to the degree of symmetry of the object representation.

5. The method according to claim 1, wherein, when the object representation comprises a degree of symmetry, the manufactured object comprises an alignment feature in an alignment feature region of the manufactured object to break the symmetry of the manufactured object manufactured according to the object data file.

6. The method according to claim 5, wherein aligning the object scan with the object representation comprises:
identifying the alignment feature from a candidate alignment feature regions of the manufactured object; and
aligning the alignment feature of the manufactured object with the alignment feature represented with the object data file.

7. The method according to claim 6, wherein aligning the alignment feature of the manufactured object with the alignment feature included with the object representation comprises:
identifying the alignment feature in the object scan of the manufactured object using pattern identification and neural network-based pattern identification.

8. The method according to claim 1, wherein computationally reading the manufacturing parameter identifier comprises converting the region of interest of the aligned object scan to a depth map and reading the manufacturing parameter identifier using a neural network or optical character recognition.

9. The method according to claim 5, wherein the alignment feature region and the region of interest coincide, and wherein the alignment feature and the manufacturing parameter identifier are the same feature, the feature thereby both breaking the symmetry of the manufactured object and indicating the manufacturing parameter of the manufactured object.

10. The method according to claim 1, wherein the method comprises:
manufacturing the object according to the object data file and manufacturing the manufacturing parameter identifier in the region of interest defined in the object data file.

11. The method according to claim 1, wherein, for a plurality of manufactured objects manufacturing according to the object data file, each manufactured object comprises a unique manufacturing parameter identifier in a region of interest defined in the object data file, and the method comprises:
aligning the object scan obtained from each manufactured object manufactured according to the object data file with the object representation obtained from the object data file; and
computationally reading the unique manufacturing parameter identifier in the region of interest of each of the aligned object scans.

12. An apparatus comprising:
a processor;
a computer readable storage coupled to the processor; and
an instruction set to cooperate with the processor and the computer readable storage to:
obtain an object scan of an object manufactured by a 3D manufacturing apparatus, the object manufactured according to an object data file defining the object geometry and a region of interest of the object, the object comprising a manufacturing parameter identifier in the region of interest indicating a manufacturing parameter of the manufactured object;
align the obtained object scan with an object representation obtained from the object data file;
extract the region of interest from the aligned object scan according to the region of interest defined in the object data file; and
read the manufacturing parameter identifier in the region of interest of the aligned object scan.

13. A non-transitory computer readable storage medium having executable instructions stored thereon which, when executed by a processor, cause the processor to:
match a 3D object scan of a 3D manufactured object according to a CAD object data file with a 3D representation of the object from the CAD object data, wherein the 3D manufactured object comprises a region of interest containing a label, the label identifying a manufacturing parameter associated with the 3D manufactured object;
identify the region of interest in the 3D object scan based on the region of interest in the 3D representation; and
obtain the manufacturing parameter from the region of interest identified in the 3D object scan.

14. The non-transitory computer readable storage medium having executable instructions stored thereon of claim 13 which, when executed by a processor, cause the processor to match the 3D object scan with the 3D representation of the object by:
identifying a fiducial feature included in the 3D object scan;
aligning the 3D object scan with the 3D representation by aligning the fiducial feature in the 3D object scan with a corresponding fiducial feature of the 3D representation.

15. The non-transitory computer readable storage medium having executable instructions stored thereon of claim 14 which, when executed by a processor, cause the processor to obtain the manufacturing parameter from the region of interest by identifying an alphanumeric character present in the 3D manufactured object using character recognition, the alphanumeric character representing the manufacturing parameter.
